(19) United States
(12) Patent Application Publication
(10) Pub. No.: US 2024/0128845 A1
(43) Pub. Date: Apr. 18, 2024

(54) AXIAL FLUX ELECTRIC MACHINE INCLUDING SKEWED POLES

(71) Applicant: GM Global Technology Operations LLC, Detroit, MI (US)

(72) Inventors: Jian Yao, Shanghai (CN); Chengwu Duan, Shanghai (CN); Denghao Fan, Shanghai (CN); Vincent Fedida, Shanghai (CN); Thomas W. Nehl, Shelby Twp., MI (US)

(21) Appl. No.: 17/975,957

(22) Filed: Oct. 28, 2022

(30) Foreign Application Priority Data
Oct. 12, 2022 (CN) 202211249306.1

(51) Int. Cl. H02K 29/03; B60L 50/60; H02K 21/24

(52) U.S. Cl. CPC H02K 29/03; B60L 50/60; H02K 21/24; H02K 2201/06

(57) ABSTRACT

A member for an axial flux electric machine, in accordance with a non-limiting example, includes a support member having a first surface, a second surface opposite the first surface, an outer annular edge, and an inner annular edge that defines an opening having a center point. A plurality of members is mounted on one of the first surface and the second surface. Each of the plurality of members has a centerline that passes through the outer annular edge and the inner annular edge without passing through the center point creating a torque ripple reducing asymmetry in the member.

### CROSS-REFERENCE TO RELATED APPLICATIONS

This application claims priority to Chinese Patent Application No. CN202211249306.1, filed Oct. 12, 2022, the contents of which are incorporated by reference herein in their entirety.

### INTRODUCTION

The subject disclosure relates to electric machines and, more particularly, to an axial flux electric machine having skewed poles.

Electric machines typically include a stator that is supported at an internal surface of a housing and a rotor that is positioned adjacent the stator. The stator includes stator windings that are energized to produce a magnetic field within the rotor. The magnetic field causes the rotor to spin and produce power. During operation, torque ripples occur as a result of magnetic flux in the motor. Axial flux electric motors experience a higher level of torque ripples than radial flux electric motors.

Torque ripple causes a periodic increase or decrease in output torque as the motor shaft rotates, it is measured as the difference in maximum and minimum torque over one complete revolution. Torque ripple effects motor output efficiency. As such, a number of systems have been developed to reduce torque ripple. For example, motor controllers that adjust applied voltage to the motor are often used to reduce torque ripple. While effective, motor controllers are expensive, require a fast response, and torque ripple compensation provided by a motor controller can lead to undesirable losses. Accordingly, it would be desirable to create an axial flux electric machine having reduced torque ripple without the need for a motor controller.

### SUMMARY

A member for an axial flux electric machine, in accordance with a non-limiting example, includes a support member having a first surface, a second surface opposite the first surface, an outer annular edge, and an inner annular edge that defines an opening having a center point. A plurality of members is mounted on one of the first surface and the second surface. Each of the plurality of members has a centerline that passes through the outer annular edge and the inner annular edge without passing through the center point creating a torque ripple reducing asymmetry in the member.

In addition to one or more of the features described herein each of the plurality of members includes a radially outermost end, a radially innermost end, a first side extending between the radially outermost end and the radially innermost end, the first side having a first angle and a second side extending between the radially outermost end and the radially innermost end opposite the first side, the second side having a second angle that is distinct from the first angle.

In addition to one or more of the features described herein the first side includes a first plurality of step features.

In addition to one or more of the features described herein each of the first plurality of step features include a first rise and a first run.

In addition to one or more of the features described herein the second side includes a second plurality of step features, each of the second plurality of step features including a second rise and a second run, wherein at least one of the second rise and the second run is distinct from corresponding ones of the first rise and the first run.

In addition to one or more of the features described herein the first side includes a first portion having a first angle and a second portion having a second angle that is distinct from the first angle.

In addition to one or more of the features described herein the first portion extends from the radially outermost end away from the first side at the first angle and the second portion extends from the first portion to the radially innermost end toward the second side at the second angle.

In addition to one or more of the features described herein the second side includes a first section extending from the radially outermost end toward the first side at a third angle and a second section extending from the first section to the radially innermost end away from the first side at a fourth angle that is distinct from the third angle.

In addition to one or more of the features described herein the plurality of members define permanent magnet (PM) members.

In addition to one or more of the features described herein the plurality of members define stator winding members.

A vehicle, in accordance with a non-limiting example, includes a body, a rechargeable energy storage system (RESS) mounted in the body, and an axial flux motor connected to the RESS. The axial flux motor includes a rotor including a plurality of permanent magnet (PM) members and a stator arranged adjacent the rotor. The stator includes a plurality of stator winding members. At least one of the plurality of PM members and one of the plurality of stator winding members creating a torque ripple reducing asymmetry in the axial flux motor.

In addition to one or more of the features described herein at least one of the plurality of PM members and one of the plurality of stator winding members includes a radially outermost end, a radially innermost end, a first side extending between the radially outermost end and the radially innermost end, the first side having a first angle and a second side extending between the radially outermost end and the radially innermost end opposite the first side, the second side having a second angle that is distinct from the first angle creating the torque ripple reducing asymmetry in the one of the stator and the rotor.

In addition to one or more of the features described herein the first side includes a first plurality of step features, each of the first plurality of step features include a first rise and a first run.

In addition to one or more of the features described herein the second side includes a second plurality of step features, each of the second plurality of step features including a second rise and a second run, wherein at least one of the second rise and the second run is distinct from corresponding ones of the first rise and the first run creating the torque ripple reducing asymmetry between the first side and the second side.

In addition to one or more of the features described herein the first side includes a first portion having a first angle and a second portion having a second angle that is distinct from the first angle.

In addition to one or more of the features described herein the first portion extends from the radially outermost end away from the first side at the first angle and the second portion extends from the first portion to the radially innermost end toward the second side at the second angle creating the torque ripple reducing asymmetry between the first side and the second side.

In addition to one or more of the features described herein the second side includes a first section extending from the radially outermost end toward the first side at a third angle and a second section extending from the first section to the radially innermost end away from the first side at a fourth angle that is distinct from the third angle.

In addition to one or more of the features described herein the rotor includes a first rotor having a first support member including a first plurality of PM members and a second rotor having a second support member including a second plurality of PM members, the first plurality of PM members being circumferentially off-set relative to corresponding ones of the second plurality of PM members creating the torque ripple reducing asymmetry between the first rotor and the second rotor.

In addition to one or more of the features described herein the first plurality of PM members being circumferentially off-set relative to the second plurality of PM members by about at least 3°.

In addition to one or more of the features described herein the stator includes a first stator having a first support member including a first plurality of stator winding members and a second stator having a second plurality of stator winding members, the first plurality of stator winding members being circumferentially off-set relative to corresponding ones of the second plurality of stator winding members creating the torque ripple reducing asymmetry between the first stator and the second stator.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a side view of a vehicle including an axial flux motor having skewed poles, in accordance with a non-limiting example;

FIG. 2 is a partial cross-sectional view of an axial-flux motor including a stator disposed between two rotors having skewed poles, in accordance with a non-limiting example;

FIG. 3 is a disassembled view of the stator disposed between two rotors of FIG. 2, in accordance with a non-limiting example;

FIG. 4 is a plan view of a skewed pole of one of the rotors of FIG. 3, in accordance with a non-limiting example;

FIG. 5 is a plan view of a skewed pole of one of the rotors of FIG. 3, in accordance with another non-limiting example;

FIG. 6 is a plan view of a skewed pole of one of the rotors of FIG. 3, in accordance with yet another a non-limiting example;

FIG. 7 is a partial cross-sectional view of an axial-flux motor including a rotor disposed between two stators having skewed poles, in accordance with a non-limiting example;

FIG. 8 is a disassembled view of the rotor disposed between two stators of FIG. 7, in accordance with a non-limiting example;

FIG. 9 is a plan view of a skewed pole of one of the stators of FIG. 8, in accordance with a non-limiting example;

FIG. 10 is a plan view of a skewed pole of one of the stators of FIG. 8, in accordance with another non-limiting example; and

FIG. 11 is a plan view of a skewed pole of one of the stators of FIG. 8, in accordance with yet another a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

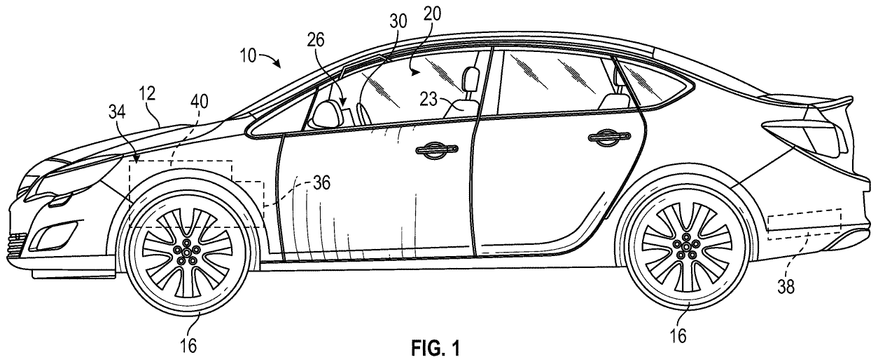

A vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. That is, changing a position of two of the plurality of wheels 16 relative to body 12 will cause vehicle 10 to change direction. Body 12 defines, in part, a passenger compartment 20 having seats 23 positioned behind a dashboard 26. A steering control 30 is arranged between seats 23 and dashboard 26. Steering control 30 is operated to control the orientation of the steerable wheel(s).

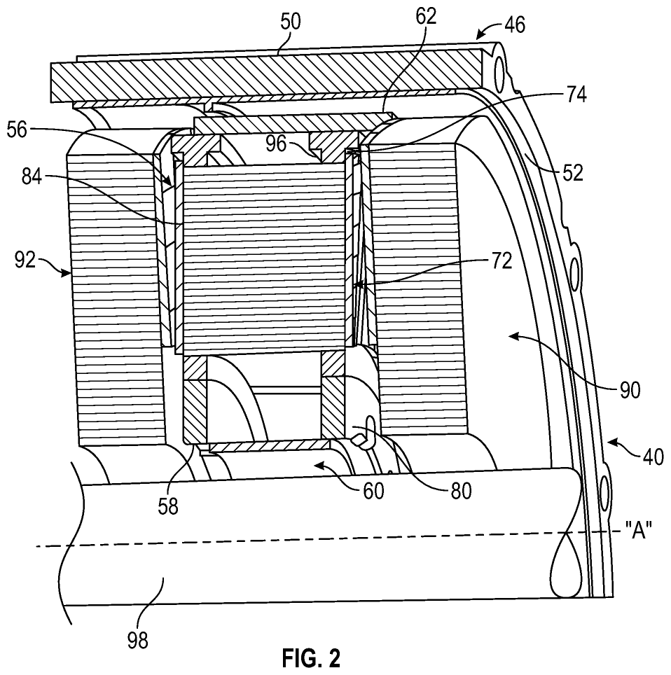

Vehicle 10 includes an electric motor 34 connected to a transmission 36 that provides power to one or more of the plurality of wheels 16. A rechargeable energy storage system (RESS) 38 provides power to electric motor 34. In a non-limiting example, electric motor 34 takes the form of an axial flux electric motor 40 having a housing 46 as shown in FIG. 2. Housing 46 includes an outer surface 50 and an inner surface 52.

In a non-limiting example, a stator 56 is fixedly mounted within housing 46. Stator 56 includes an inner annular support member 58 that defines a passage 60, and an outer annular member 62. A plurality of poles or stator winding members, one of which is indicated at 72, is disposed between inner annular support member 58 and outer annular member 62. Each of the plurality of stator winding members includes a stator segment support member 74. The plurality of stator winding members 72 also includes a first axially facing surface 80 and a second axially facing surface 84. A first rotor 90 is arranged at and spaced from first axially facing surface 80 and a second rotor 92 is arranged at and spaced from second axially facing surface 84. First and second rotors 90 and 92 are supported for rotation with a shaft 98 that passes through passage 60 of stator 56 and connects with transmission 36. Thus, first and second rotors 90 and 92 rotate relative to stator 56.

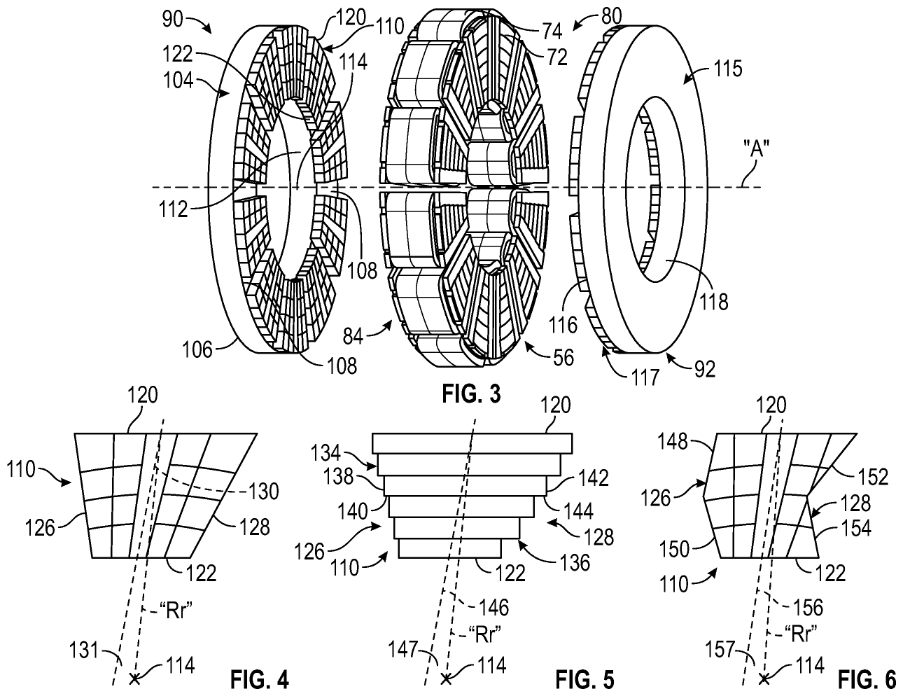

Reference will now follow to FIG. 3 in describing first rotor 90. First rotor 90 includes a first permanent magnet (PM) support member 104 having a first axially facing surface 106 and a second axially facing surface 108. A first plurality of rotor poles or permanent magnet (PM) members, one of which is indicated at 110 is mounted to second axially facing surface 108. First rotor 90 is also shown to include a central opening 112 that having a center point 114 that defines an axis of rotation “A” of shaft 98.

Second rotor 92 includes a second rotor PM support member 115 having a first axially facing surface 116 that supports a second plurality of permanent magnet (PM) members, one of which is indicated at 117 that face first plurality of PM members 110. Second rotor PM support member 115 includes a central opening 118 having a center point (not separately labeled) that lies along axis of rotation “A”. In a non-limiting example, each of the first plurality of PM members 110 is circumferentially off-set relative to corresponding ones of the second plurality of PM members 117. In a non-limiting example, the circumferential off-set has a mechanical angle of about 3° and an electrical angle of about 15° as described in EQ (1) and EQ (2). The circumferential off-set or out-of-phase arrangement of PM members 110 and 117 creates a skewed rotor pole design or an asymmetry between the poles on first rotor 90 and the poles on second rotor 92 that reduces torque ripple.

$${α}_{rm} = \frac{2 π}{LCM ( {Z}_{1} , 2 p )} \times \frac{n - 1}{n} = \frac{360}{LCM ( 12 , 10 )} \times \frac{2 - 1}{2} = 3 ° \qquad EQ ( 1 )$$

$${α}_{re} = \frac{2 p π}{LCM ( {Z}_{1} , 2 p )} \times \frac{n - 1}{n} = \frac{360 \times 5}{LCM ( 12 , 10 )} \times \frac{2 - 1}{2} = 15 ° \qquad EQ ( 2 )$$

where:
   Z1 is the number of slots, and p is the number of pole pairs
   LCM is the least common multiple of slot and slot pole numbers
   n is the segment of rotor to be skewed, here n=2 with two (2) rotor discs.

In another non-limiting example, instead of indexing one rotor relative to another to create the circumferential off-set. PM members 110 and/or PM members 117 may be designed to themselves establish the off-set. Reference will now follow to FIG. 4 in describing one of the plurality of PM members 110 with an understanding that remaining ones of the plurality of PM members 110 are similarly formed. PM member 110 includes a radially outermost end 120 and a radially innermost end 122. A first side 126 extends between radially outermost end 120 and radially innermost end 122. A second side 128, that is opposite first side 126 also extends between radially outermost end 120 and radially innermost end 122. First side 126 extends at a first angle and second side 128 extends at a second angle that is distinct from the first angle. In this manner, PM member 110 includes a center line 130 that is skewed at a skew angle 131 relative to a radius “Rᵣ” of rotor 90. That is, center line 130 does not extend through center point 114.

Reference will now follow to FIG. 5 in describing PM member 110 in accordance with another non-limiting example. PM member 110 includes a first plurality of step features 134 formed in first side 126 and a second plurality of step features 136 formed in second side 128. First plurality of step features 134 include a first rise 138 and a first run 140. Second plurality of step features 136 include a second rise 142 and a second run 144. In a non-limiting example first rise 138 has a length that is different from second rise 142 and first run 140 has a length that is different from second run 144. In this manner, PM member 110 includes a center line 146 that is skewed at a skew angle 147 relative to radius “Rᵣ”. That is, center line 146 does not extend through center point 114.

Reference will now follow to FIG. 6 in describing PM member 110 in accordance with yet another non-limiting example. First side 126 includes a first portion 148 and a second portion 150 that extends at an angle relative to first portion 148. Second side 128 includes a first section 152 and a second section 154 that extends at an angle relative to first section 152. In this manner, PM member 110 includes a center line 156 that is skewed at a skew angle 157 relative to radius “Rᵣ”. That is, the shape of the PM member 110 creates an asymmetry the reduces torque ripple effects.

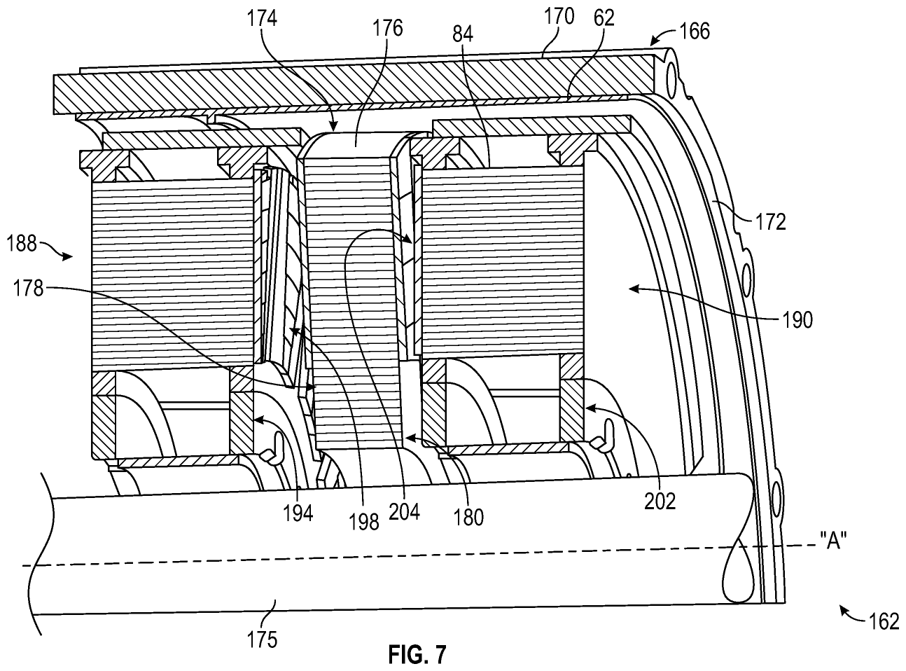

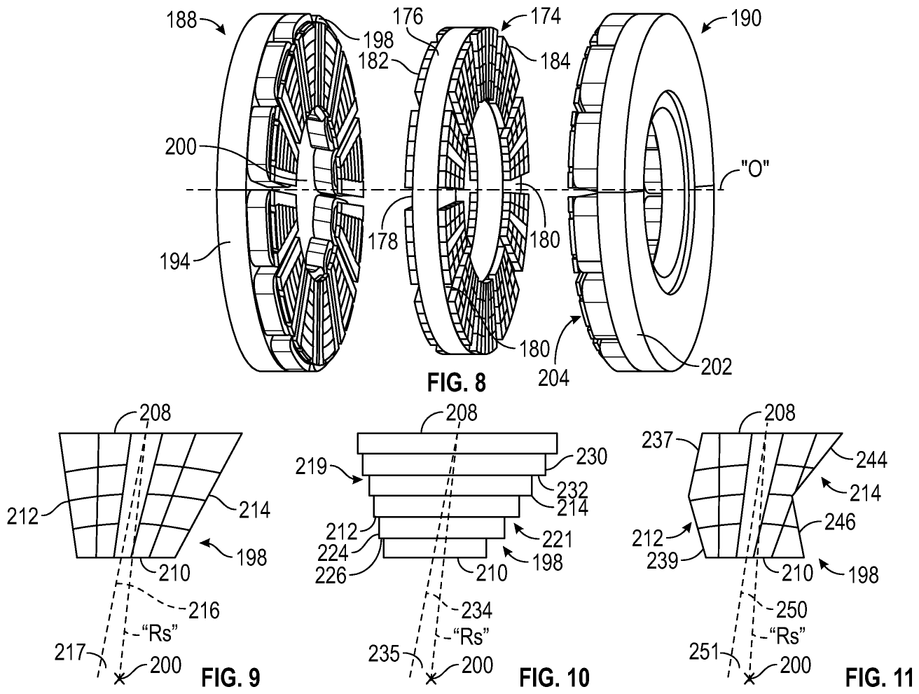

Reference will now follow to FIGS. 7 and 8 in describing an axial flux electric machine 162 in accordance with another non-limiting example. Axial flux electric machine 162 includes a housing 166 having an outer surface 170 and an inner surface 172. A rotor 174 is arranged in housing 166 and is rotatably supported on a shaft 175. Rotor 176 includes a first axially facing surface section 178 and a second axially facing surface section 180. A first plurality of PM members 182 is arranged on first axially facing surface section 178 and a second plurality of PM members 184 is arranged on second axially facing surface section 180.

A first stator 188 is arranged at first axially facing surface section 178 of rotor 174. A second stator 190 is arranged at second axially facing surface section 180 of rotor 174. First stator 188 is fixedly mounted in housing 166 and includes a stator support member 194. A first plurality of stator winding members 198 is mounted to stator support member 194. First stator 188 includes a center point 200 through which passes shaft 175.

Second stator 190 includes a stator support member 202 that supports a second plurality of stator winding members 204 With this arrangement, rotor 174 rotates relative to first stator 188 and second stator 190. In a non-limiting example, each of the first plurality of plurality of stator winding members 198 is circumferentially off-set relative to corresponding ones of the second plurality of stator winding members 204 as shown by reference line “0”. In a non-limiting example, the circumferential off-set creating a mechanical angle of about 3° and an electrical angle of about 15° as described in EQ (3) and EQ (4). The circumferential off-set or out-of-phase arrangement of the stator winding members 198 and 204 creates a skewed stator design or an asymmetry of first stator 188 relative to second stator 190 that reduces torque ripple.

$${α}_{sm} = \frac{2 π}{LCM ( {Z}_{1} , 2 p )} \times \frac{n - 1}{n} = \frac{360}{LCM ( 12 , 10 )} \times \frac{2 - 1}{2} = 3 ° \qquad EQ ( 3 )$$

$${α}_{se} = \frac{2 p π}{LCM ( {Z}_{1} , 2 p )} \times \frac{n - 1}{n} = \frac{360 \times 5}{LCM ( 12 , 10 )} \times \frac{2 - 1}{2} = 15 ° \qquad EQ ( 4 )$$

where:
   Z₁ is the number of slots, and p is the number of pole pairs
   LCM is the least common multiple of slot and slot pole numbers
   n is the segment of the stator to be skewed, here n=2 with two (2) stators.

In another non-limiting example, instead of physically indexing one stator relative to another to create the circumferential pole off-set. Stator winding members 198, and/or stator winding members 204, may be designed to themselves creates the off-set. Reference will now follow to FIG. 9 in describing one of the plurality of stator winding members 198 with an understanding that remaining ones of the plurality of stator winding members 198 are similarly formed. Stator winding member 198 includes a radially outermost end 208 and a radially innermost end 210. A first side 212 extends between radially outermost end 208 and radially innermost end 210. A second side 214, that is opposite first side 212 also extends between radially outermost end 208 and radially innermost end 210. First side 212 extends at a first angle and second side 214 extends at a second angle that is distinct from the first angle. In this manner, stator winding member 198 includes a center line 216 that is skewed at a skew angle 217 relative to a radius “Rₛ of stator 188. That is, center line 216 does not extend through center point 200.

Reference will now follow to FIG. 10 in describing stator winding member 198 in accordance with another non-limiting example. Stator winding member 198 includes a first plurality of step features 219 formed in first side 212 and a second plurality of step features 221 formed in second side 214. First plurality of step features 219 includes a first rise 224 and a first run 226. Second plurality of step features 221 include a second rise 230 and a second run 232. In a non-limiting example first rise 224 has a length that is different from second rise 230 and first run 226 has a length that is different from second run 232. In this manner, stator winding member 198 includes a center line 234 that is skewed at a skew angle 235 relative to a radius “Rₛ”. That is, center line 234 does not extend through center point 200.

Reference will now follow to FIG. 11 in describing stator winding member 198 in accordance with yet another non-limiting example. First side 212 includes a first portion 237 and a second portion 239 that extends at an angle relative to first portion 237. Second side 214 includes a first section 244 and a second section 246 that extends at an angle relative to first section 244. In this manner, stator winding member 198 includes a center line 250 that is skewed at a skew angle 251 relative to a radius “Rₛ”. That is, center line 250 does not extend through center point 200. By skewing center line 250 relative to center point 200 torque ripple produced by axial flux electric motor 40 is reduced.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A member for an axial flux electric machine comprising:
a support member having a first surface, a second surface opposite the first surface, an outer annular edge, and an inner annular edge that defines an opening having a center point; and
a plurality of members mounted on one of the first surface and the second surface, each of the plurality of members having a centerline that passes through the outer annular edge and the inner annular edge without passing through the center point creating a torque ripple reducing asymmetry in the member.

2. The member according to claim 1, wherein each of the plurality of members includes a radially outermost end, a radially innermost end, a first side extending between the radially outermost end and the radially innermost end, the first side having a first angle and a second side extending between the radially outermost end and the radially innermost end opposite the first side, the second side having a second angle that is distinct from the first angle.

3. The member according to claim 2, wherein the first side includes a first plurality of step features.

4. The member according to claim 3, wherein each of the first plurality of step features include a first rise and a first run.

5. The member according to claim 4, wherein the second side includes a second plurality of step features, each of the second plurality of step features including a second rise and a second run, wherein at least one of the second rise and the second run is distinct from corresponding ones of the first rise and the first run.

6. The member according to claim 2, wherein the first side includes a first portion having a first angle and a second portion having a second angle that is distinct from the first angle.

7. The member according to claim 6, wherein the first portion extends from the radially outermost end away from the first side at the first angle and the second portion extends from the first portion to the radially innermost end toward the second side at the second angle.

8. The member according to claim 7, wherein the second side includes a first section extending from the radially outermost end toward the first side at a third angle and a second section extending from the first section to the radially innermost end away from the first side at a fourth angle that is distinct from the third angle.

9. The member according to claim 1, wherein the plurality of members define a plurality of permanent magnet (PM) members.

10. The member according to claim 1, wherein the plurality of members define a plurality of stator winding members.

11. A vehicle comprising:
a body;
a rechargeable energy storage system (RESS) mounted in the body; and
an axial flux motor connected to the RESS, the axial flux motor comprising:
a rotor including a plurality of permanent magnet (PM) members; and
a stator arranged adjacent the rotor, the stator including a plurality of stator winding members, at least one of the plurality of PM members and one of the plurality of stator winding members creating a torque ripple reducing asymmetry in the axial flux motor.

12. The vehicle according to claim 11, wherein at least one of the plurality of PM members and one of the plurality of stator winding members includes a radially outermost end, a radially innermost end, a first side extending between the radially outermost end and the radially innermost end, the first side having a first angle and a second side extending between the radially outermost end and the radially innermost end opposite the first side, the second side having a second angle that is distinct from the first angle creating the torque ripple reducing asymmetry in the one of the stator and the rotor.

13. The vehicle according to claim 12, wherein the first side includes a first plurality of step features, each of the first plurality of step features include a first rise and a first run.

14. The vehicle according to claim 13, wherein the second side includes a second plurality of step features, each of the second plurality of step features including a second rise and a second run, wherein at least one of the second rise and the second run is distinct from corresponding ones of the first rise and the first run creating the torque ripple reducing asymmetry between the first side and the second side.

15. The vehicle according to claim 12, wherein the first side includes a first portion having a first angle and a second portion having a second angle that is distinct from the first angle.

16. The vehicle according to claim 15, wherein the first portion extends from the radially outermost end away from the first side at the first angle and the second portion extends from the first portion to the radially innermost end toward the second side at the second angle creating the torque ripple reducing asymmetry between the first side and the second side.

17. The vehicle according to claim 16, wherein the second side includes a first section extending from the radially outermost end toward the first side at a third angle and a second section extending from the first section to the radially innermost end away from the first side at a fourth angle that is distinct from the third angle.

18. The vehicle according to claim 11, wherein the rotor includes a first rotor having a first support member including a first plurality of PM members and a second rotor having a second support member including a second plurality of PM members, the first plurality of PM members being circumferentially off-set relative to corresponding ones of the second plurality of PM members creating the torque ripple reducing asymmetry between the first rotor and the second rotor.

19. The vehicle according to claim 18, wherein the first plurality of PM members being circumferentially off-set relative to the second plurality of PM members by about at least 3°.

20. The vehicle according to claim 11, wherein the stator includes a first stator having a first support member including a first plurality of stator winding members and a second stator having a second plurality of stator winding members, the first plurality of stator winding members being circumferentially off-set relative to corresponding ones of the second plurality of stator winding members creating the torque ripple reducing asymmetry between the first stator and the second stator.
